(19) United States
(12) Patent Application Publication
(10) Pub. No.: US 2012/0196267 A1
(43) Pub. Date: Aug. 2, 2012

(54) ONLINE DISCUSSION ABILITY AUTHENTICATION METHOD AND SYSTEM FOR PERFORMING METHOD

(75) Inventor: Gyeong Ho Hur, Seoul (KR)

(73) Assignee: ONSOTONG CO., LTD., Dongdaemun-Gu, Seoul (KR)

(21) Appl. No.: 13/500,767

(22) PCT Filed: Oct. 8, 2010
(86) PCT No.: PCT/KR2010/006915

§ 371 Date: Apr. 6, 2012

(30) Foreign Application Priority Data
Oct. 8, 2009 (KR) 10-2009-0095853
Apr. 8, 2010 (KR) 10-2010-0032263

(51) Int. Cl. G09B 7/00

(52) U.S. Cl. 434/353

(57) ABSTRACT

Disclosed is a discussion solution providing system. The discussion solution providing system opens a discussion room with a particular topic, and transmits image information of each discussion participant participating in the opened discussion room to terminals of each discussion participant, so that the transmitted image information may be displayed on discussion UIs corresponding to each discussion participant. The discussion solution providing system progresses discussion in a tournament type, thereby inspiring the participants to have competitive spirits and increasing the educational effect.

### TECHNICAL FIELD

Embodiments of the present inventive concepts relate to an on-line debate competence certification method, and more particularly, to a system which may educate a speech and a debate competence systematically through an automated solution and one's debate competence may be fairly evaluated by and a method thereof.

### BACKGROUND ART

As an era of democratic communication comes, communication competence has become a standard to weigh total capability of a person, and each field of society needs a person having communication competence.

Companies want individuals with communication skills who plan, perform, manage and expand works efficiently, so the companies are continuing efforts to measure communication skills by utilizing methods such as a group/in-depth interview before employment.

Moreover, it is a real situation that companies invest their resources to maximize communication competences of members with various training methods even after employment. However, with institutional problems of our education system, it is true that we are lack of not only systematic speech and debate education from infancy but also an adequate training institute for systematic education. In addition, although speaking skill among communication skills such as reading skill, writing skill and speaking skill is key skill of individuals, it has not been educated as important skill. Furthermore, there has not been a well education on discussion skill as well as speaking skill.

### DETAILED DESCRIPTION OF THE INVENTION

### Technical Problem

The present inventive concepts provides a debate solution providing system which may develop contents with competent people having expertise by enabling training and education of communication through educational service and training for strengthening communication competence and solutions for practical competitions, and a method thereof.

In addition, the present inventive concepts provides an on-line debate competence certification method which may select a debate format through on-line, and measure and rate a debate competence so that individuals may receives a feedback for a result of a debate they performed, and a system performing the method.

### ADVANTAGEOUS EFFECT

A debate solution providing system of the present invention has an operation rule for each of various debate formats through an automated solution, so that debate participants automatically perform a debate suited for debate format and get naturally familiar to the format and culture of debate.

In addition, objective and systematic assessment of an expert on a debate may strengthen competence of debate and communication. Moreover, participants (or speakers) may participate in a debate easily through on-line and receive feedback through images where their speeches are recorded, so that they may recognize their problems easily and recorded speech may be utilized as various types of contents.

Additionally, a debate solution providing system may operate a debate in a tournament way, so that it may inspire great competition to participants and increase effectiveness of education.

Besides, since on-line debate competence certification method enables a participant to select freely his favorite debate format and a debate process is evaluated and scored by an evaluator (or judge), it may improve debate competence.

### BEIEF DESCRIPTION OF DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a debate solution providing system according to an example embodiment of the present inventive concepts;

FIG. 2 explains a process in which a debate room is opened according to the debate solution providing system according to an example embodiment of the present inventive concepts;

FIGS. 3 to 7 explain an operation method of a debate by debate format operated in the debate solution providing system according to an example embodiment of the present inventive concepts;

FIG. 8 is an example embodiment of a screen which is provided to a terminal of each of debate participants by the debate solution providing system according to an example embodiment of the present inventive concepts;

FIG. 9 is an example embodiment of a screen which is provided to the terminal of each of debate participants by the debate solution providing system according to another example embodiment of the present inventive concepts;

FIG. 10 is a schematic data flow of a system which may perform on-line debate competence certification method according to an example embodiment of the present inventive concepts;

FIG. 11 is a schematic block diagram of an on-line debate competence certification server illustrated in FIG. 10;

FIG. 12 is a schematic data flow of the system which may perform the on-line debate competence certification method according to another example embodiment of the present inventive concepts; and

FIG. 13 is a schematic block diagram of the on-line debate competence certification server illustrated in FIG. 12.

### BEST MODE

In a debate solution providing system according to an example embodiment of the present inventive concepts, the debate solution providing system opens a debate room having a debate resolution, controls so that information of each of debate participants participating in the opened debating room may be transmitted to a terminal of each of the debate participants and displayed on a debate user interface (UI) corresponding to each of the debate participants, determines a speaker among the debate participants according to a pre-designated debate format, and controls a terminal of each of the debate participants to give a speaking opportunity to a determined speaker.

The debate solution providing system may enable at least one of the debate participants to choose one of the pre-designated debate formats and it may open the debate room operated according to a selected debate format. The debate solution providing system may record remarks of each of the debate participants by speaker or by nature of remarks of a speaker. The debate solution providing system may display so that a debate UI corresponding to a speaking opportunity-granted speaker may be distinguished from a debate UI of other debate participants.

The debate solution providing system may control so that a remaining time of the speaking opportunity may be displayed on a terminal of the speaking opportunity-granted speaker. The debate solution providing system may allow a judge to enter the debate room through a terminal of the judge, and control so that a judge comment input through the terminal of the judge during a debate may be transmitted and displayed on each terminal of the participants or a terminal of a participant who the judge selected among the participants.

The debate solution providing system may be characterized by that a debate result score of each of the debate participants or a team score of at least a debate team consisting of the debate participants is calculated based on at least one of a first debate score, which is calculated by a debate judgment standard set in advance in the debate solution providing system, or a second debate score, which is calculated by judgment of the judge and input through a terminal of the judge.

The debate solution providing system may judges victory or defeat of each of the debate participants or the debate team, and each of the debate participants or the debate team may be determined whether to participate in a next round of a debate contest run in tournament by the debate solution providing system according to judged victory or defeat.

The debate format may include at least one of a policy debate format, a Lincoln-Douglas Debate format, a Parliamentary Debate format, a Karl-Popper Debate format and a British Parliamentary style debate format.

In a debate solution providing system according to an example embodiment of the present inventive concepts, the debate solution providing system opens at least a debate room having a debate resolution, calculates a debate result score of each of debate participants participating in the opened debate room or a team score of at least a debate team consisting of the debate participants according to a pre-determined standard, judges victory or defeat of each of the debate participants or the debate team based on the calculated debate result score or the team score. Each of the debate participants or the debate team who wins as a result of judgment may perform a debate competition with debate participants or debate teams who win in other debate rooms.

The debate participants or the debate team may set at least one of a debate format and a debate resolution of the debate competition.

An example embodiment of the present inventive concepts is directed to an on-line debate competence certification method, including receiving, by a server, one of a plurality of debates formats, which is selected by a first user, through a terminal of the first user, selecting, by the server, at least one of a plurality of second users corresponding to a debate competence level of the first user as a debate counterpart according to a received debate format, transmitting, by the server, a debate resolution to a terminal of the first user and a terminal of the debate counterpart, recording, by the server, debate moving image received through a terminal of the first user and debate moving image received through a terminal of the debate counterpart while proceeding a moving image debate between the first user and the debate counterpart, transmitting, by the server, a recorded debate moving image file to a terminal of an evaluator when the moving image debate is over, and storing, by the server, an evaluation score for each of the first user and the debate counterpart, which is transmitted from a terminal of the evaluator, as an evaluation index for changing a debate competence level of each of the first user and the debate counterpart. The plurality of debate formats include a cross examination debate association (CEDA) format, a Lincoln-Douglas Debate format, a Parliamentary Debate format, a Karl-Popper Debate format, a British Parliamentary style debate format, an one to one debate format, or an n to m debate format (n and m are natural numbers).

The debate resolution is selected among a plurality of debate resolutions randomly by the server, an affirmative point of the debate resolution is transmitted to one of a terminal of the first user and a terminal of the debate counterpart and a negative point of the debate resolution is transmitted to the other of a terminal of the first user and a terminal of the debate counterpart.

The on-line debate competence certification method further includes transmitting, by the server, a plurality of debate resolutions to a terminal of the first user, and the server transmits the debate resolution, which is selected among the plurality of debate resolutions by the first user and input through a terminal of the first user, to a terminal of the first user and a terminal of the debate counterpart.

Another example embodiment of the present inventive concepts is directed to the on-line debate competence certification method, including receiving, by a server, a debate format selected among a plurality of debate formats by a first user through a terminal of the first user, transmitting, by the server, information on a plurality of second users corresponding to a debate competence level of the first user according to a received debate format to a terminal of the first user, generating, by the server, a debate resolution in response to selection information input through a terminal of the first user and transmitting a generated debate resolution to a terminal of the first user and a terminal of the debate counterpart when at least one of the plurality of second users is selected by the first user as a debate counterpart, recording, by the server, moving image received through a terminal of the first user and moving image received through a terminal of the debate counterpart while proceeding a moving image debate between the first user and the debate counterpart, transmitting, by the server, a recorded moving image file to a terminal of an evaluator when the moving image debate is over, and storing, by the server, an evaluation score for each of the first user and the debate counterpart, which is transmitted from the evaluator, as an evaluation index for changing a debate competence level of each of the first user and the debate counterpart. The plurality of debate formats include a cross examination debate association (CEDA) format, a Lincoln-Douglas Debate format, a Parliamentary debate format, a Karl-Popper Debate format, a British Parliamentary style debate format, an one to one debate format, or an n to m debate format (n and m are natural numbers).

An on-line debate competence certification method of the present inventive concepts may be made out in a computer program and stored in a computer readable recording medium.

An example embodiment of the present inventive concepts is directed to an on-line debate competence certification server, including a debate format processing module for transmitting a plurality of debate formats to a terminal of a first user and receiving one of the plurality of debate formats, which is selected by the first user, through a terminal of the first user, a debate counterpart selection module for selecting at least one of a plurality of second users corresponding to a debate competence level of the first user as a debate counterpart based on a debate format output from the debate format processing module, a debate resolution selection module for transmitting a debate resolution selected randomly among a plurality of debate resolutions to a terminal of the first user and a terminal of the debate counterpart in response to selection information output from the debate counterpart selection module, a recording control module for recording a debate moving image received through the terminal of the first user and the debate moving image received through a terminal of the debate counterpart while proceeding a moving image debate between the first user and the debate counterpart and transmitting a recorded debate moving image file to a terminal of an evaluator when the moving image debate is over, and a storage control module for controlling storage of an evaluation score for each of the first user and the debate counterpart, which is transmitted from the evaluator, as an evaluation index for changing a debate competence level of each of the first user and the debate counterpart. The plurality of debate formats include a cross examination debate association (CEDA) format, a Lincoln-Douglas Debate format, a Parliamentary debate format, a Karl-Popper Debate format, a British Parliamentary style debate format, an one to one debate format, or an n to m debate format (n and m are natural numbers).

An example embodiment of the present inventive concepts is directed to an on-line debate competence certification system, including a terminal of a first user, a terminal of a debate counterpart, and an on-line debate competence certification server for recording a debate moving image received from the terminal of the first user and a debate moving image received through the terminal of the debate counterpart while proceeding a moving image debate between the first user and the debate counterpart.

The on-line debate competence certification server includes a debate format processing module for transmitting a plurality of debate formats to the terminal of the first user and receiving one of the plurality of debate formats, which is selected by the first user, through the terminal of the first user, a debate counterpart selection module for selecting at least one of a plurality of second users corresponding to a debate competence level of the first user as a debate counterpart according to a debate format output from the debate format processing module, a debate resolution selection module for transmitting a debate resolution selected randomly among a plurality of debate resolutions to the terminal of the first user and a terminal of the debate counterpart in response to selection information output from the debate counterpart selection module, a recording control module for transmitting a recorded debate moving image file to a terminal of an evaluator when the moving image debate is over, and a storage control module for controlling storage of an evaluation score for each of the first user and the debate counterpart, which is transmitted from the evaluator, as an evaluation index for changing a debate competence level of each of the first user and the debate counterpart. The plurality of debate formats include a cross examination debate association (CEDA) format, a Lincoln-Douglas Debate format, a Parliamentary debate format, a Karl-Popper Debate format, a British Parliamentary style debate format, an one to one debate format, or an n to m debate format (n and m are natural numbers).

### MODE OF THE INVENTION

The embodiments are described below in order to explain the present general inventive concept, an advantage of the present inventive concepts and a purpose achieved by implementation of the present inventive concepts by referring to the figures.

In addition, ‘transmission’ of data from a component (or element) to another component (element) in the present inventive concepts means that the component may transmit the data directly to the another component or transmit the data to the another component through at least still another component.

Contrarily, ‘direct transmission’ of data from a component to another component means that the component transmits the data to the another component not through other components.

Hereinafter, reference will now be made in detail to the embodiments of the present general inventive concept, examples of which are illustrated in the accompanying drawings, wherein like reference numerals refer to the like elements throughout

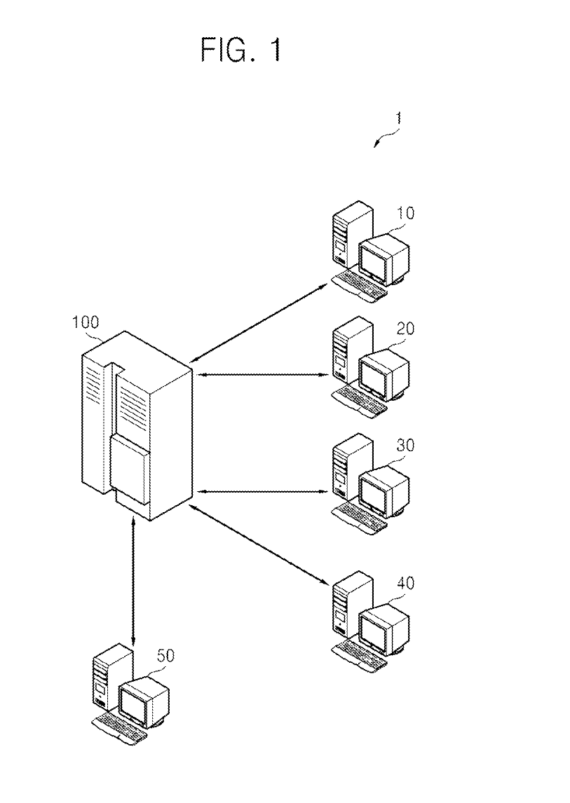

FIG. 1 is a schematic block diagram of a debate solution providing system according to an example embodiment of the present inventive concepts.

Referring to FIG. 1, the debate solution providing system 1 includes a debate server 100. The debate server 100 may transmit/receive predetermined information for embodying a debate solution providing system 1 to/from a terminal 10, 20, 30 or 40 of at least one of debate participants.

The debate server 100 may install a predetermined client application in a terminal 10, 20, 30 or 40 of the at least one of debate participants, and the debate solution providing system 1 may be defined as a configuration that includes the debate server 100 and a predetermined client application installed in a terminal 10, 20, 30 and 40 of each of the debate participants. The client application is connected to the debate server 100 through a wire/wireless network and may embody a debate solution according to a technical concept of the present invention.

On the other hand, the debate server 100 may be connected to a terminal 50 of a judge and transmit/receive predetermined information, and the judge may control operation (or managing) of a debate which proceeds in a debate room opened by the debate server 100 and evaluate each of debate participants or a debate team.

The debate server 100 may open a debate room with a subject or debate resolution which is designated in advance by an operator of the debate server 100 or open a predetermined debate room in response to a debate room opening request received from a terminal 10, 20, 30 and 40 of debate participants.

The “debate room” in the present inventive concepts may mean a virtual space or a cyber space which debate participants use to be provided with a resource or a service necessary for a debate related function provided by the debate solution providing system 1; however, it does not mean a specific physical space.

When a debate room is opened by an operator or a request of debate participants, one or more properties of a debate room may be input to the debate server 100 by the operator or the debate participants.

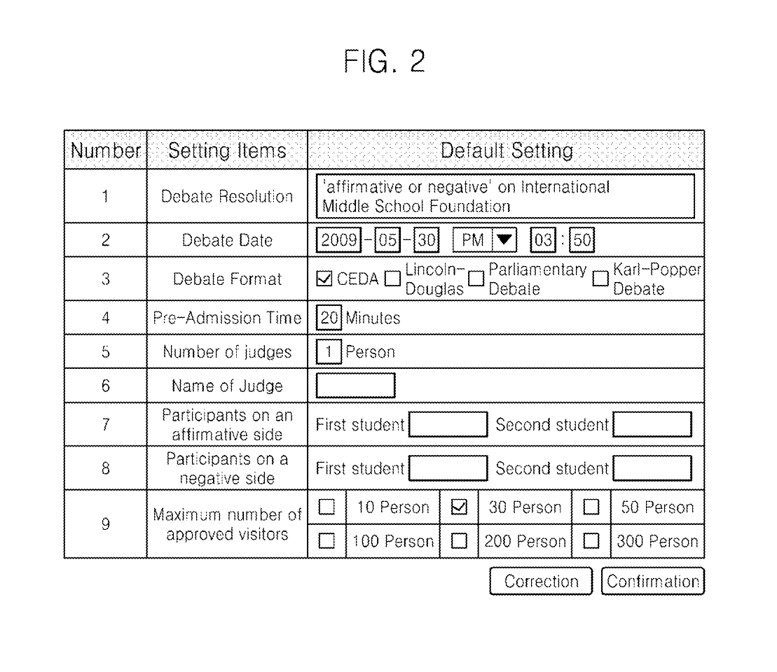

FIG. 2 explains a process of opening a debate room according to a debate solution providing system according to an example embodiment of the present inventive concepts.

Referring to FIG. 2, the debate server 100 may receive one or more properties of a debate room as illustrated in FIG. 2, which are input from the operator or the debate participants.

A debate resolution, a debate date, a debate format, pre-admission time, the number of judges, a name of judge, participants on the affirmative side (or pros), participants on the negative side (or cons), or the maximum number of allowed visitors may be properties of a debate room as illustrated in FIG. 2.

Some of properties of the debate room may be set as pre-determined default properties, and others may be set by an operator directly or may be input by debate participants directly at every opened debate room.

For example, pre-admission time, the number of judges and names of judges among the properties of the debate room may be set as default in advance in the debate server 100 or set by an operator of the debate server 100.

For example, properties of participants on an affirmative side or participants on a negative side may be specified in advance in the debate server 100 or may be remained unspecified and specified by people who want participation. When properties on a participant is specified in advance in the debate server 100, only specified participants may enter the debate room and debate. Otherwise, participants may be assigned by a predetermined method, e.g., a first-come/first-served basis or random selection basis, among participants who wish to participate after seeing a debate resolution and/or a debate format.

When a debate room is opened by a debate participant, it is certain that a person who opens the debate room can be a participant.

On the other hand, a debate solution providing system of the present inventive concepts may enforce debate proceeding to operate a debate in accordance with a pre-determined debate format, so that it may enable smooth debate in accordance with fixed rules. Here, the pre-determined debate format is also one of properties of the debate room and may be selected by an operator of the debate server 100 or debate participants.

A debate format (or type) provided by the debate solution providing system includes a cross examination debate association (CEDA) format, a Lincoln-Douglas Debate format, a Parliamentary Debate (also referred to as “parli”) format, a Karl-Popper Debate format, a British Parliamentary style debate format and so on. When one of the debate formats is selected, other properties of the debate room may be determined or changed by a selected debate format. For example, the number of participants is different according to each debate format, so that properties of participants may be changed.

When a debate format is determined among the debate formats by an operator or debate participants, a debate solution providing system of the present inventive concepts may limit debate participants' usage of resource, function and/or service in a debate room so that a debate may proceed in accordance with a determined format. Accordingly, a debate may proceed according to a pre-determined and planned format, and debate participants are forced to follow a debate format, so that they are accustomed to a representative debate format and a debate culture.

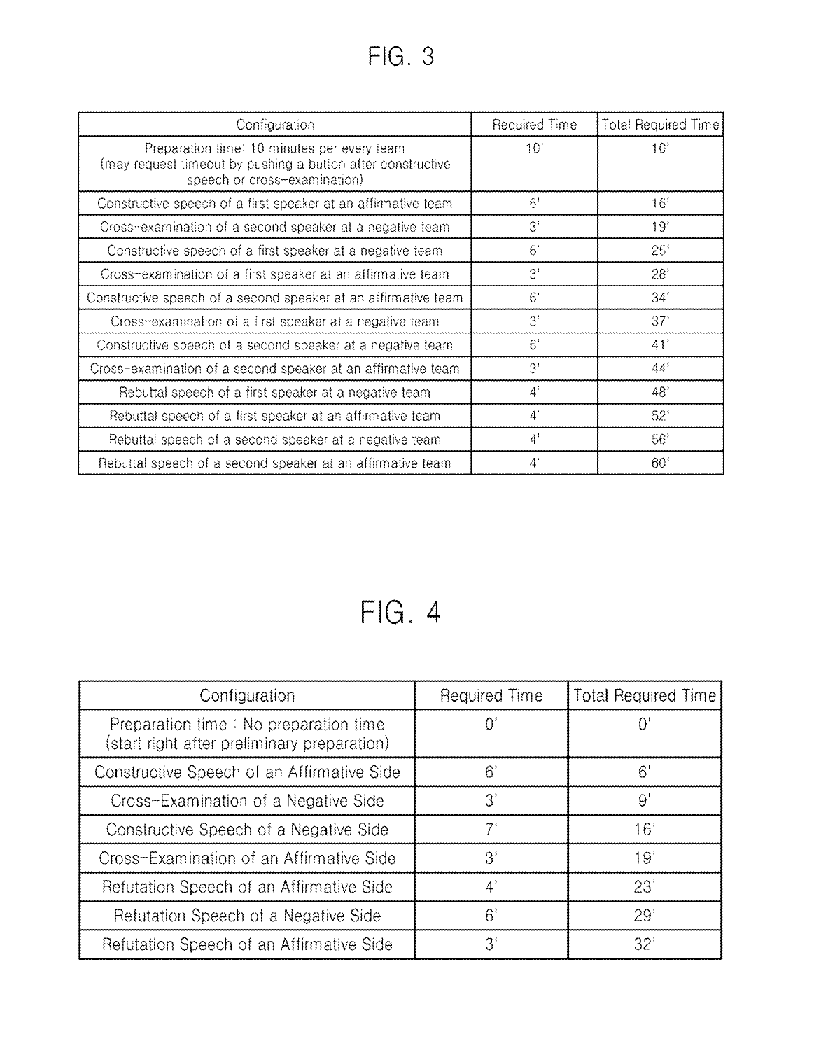

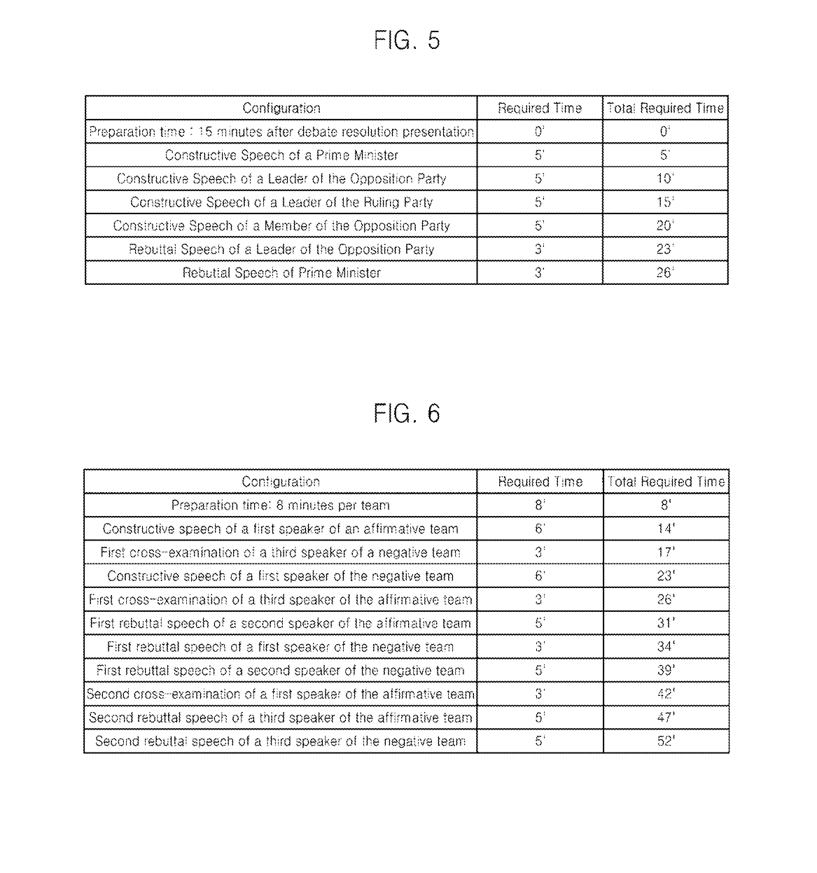

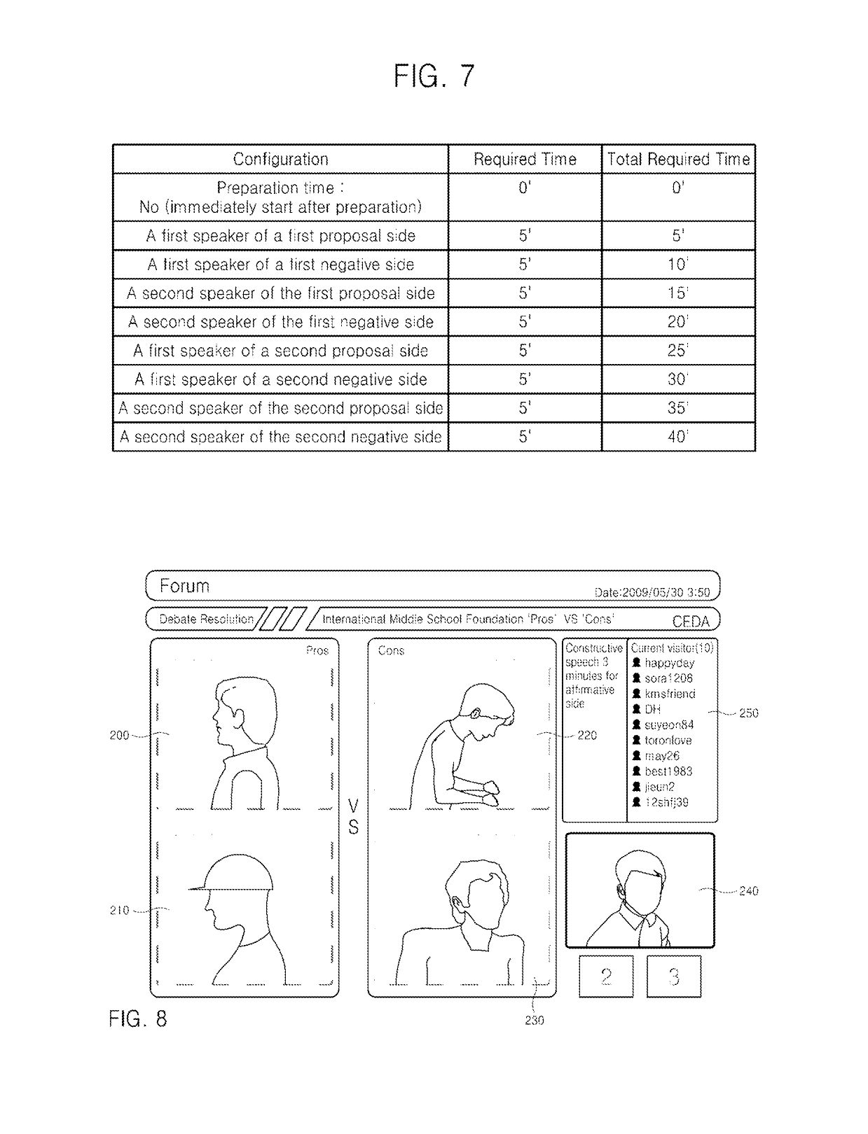

FIGS. 3 to 7 explain an operation method of debate by debate format operated in a debate solution providing system according to an example embodiment of the present inventive concepts.

First of all, FIG. 3 illustrates an operation rule of a Cross Examination Debate Association (CEDA) debate format. The CEDA format is mainly used for a policy debate. As illustrated in FIG. 3, the CEDA format is a format where participants are divided into an affirmative (or pros) team and a negative (or cons) team and debate on a specific debate resolution, and a debate format or a feature of speech may be configured with constructive speech, cross-examination and rebuttal speech.

In a CEDA format, a debate is operated in a following order once preparation time is passed. A constructive speech of a first speaker of an affirmative team, cross-examination of a second speaker of the negative team, a constructive speech of a first speaker of the negative team, cross-examination of the first speaker of the affirmative team, a constructive speech of a second speaker of the affirmative team, cross-examination of the first speaker of the negative team, a constructive speech of a second speaker of the negative team, cross-examination of the second speaker of the affirmative team, rebuttal speech of the first speaker of the negative team, rebuttal speech of the first speaker of the affirmative team, rebuttal speech of the second speaker of the negative team, and rebuttal speech of the second speaker of the affirmative team.

Accordingly, a debate solution providing system of the present inventive concepts, when a debate format of a debate room is assigned to a CEDA format, controls a terminal 10, 20, 30 and 40 of debate participants, who enter a debate room and perform a debate, to proceed a debate like the above, and provides a predetermined debate user interface (UI) for proceeding a debate more officially and objectively to the terminal 10, 20, 30 and 40 of the debate participants.

FIG. 8 is an example embodiment of a screen which a debate solution providing system of the present inventive concepts provides to a terminal of each of debate participants.

Referring to FIG. 8, the debate solution providing system provides a debate UI 200, 210, 220 and 230 for displaying image information of each of debate participants participating in a debate room to each terminal 10, 20, 30 and 40 of debate participants. In addition, a judge UI 240, which may provide image information of a judge, and/or a predetermined visitor UI 250 where information of visitors, who may enter the debate room and observe a debate without participating in the debate, is displayed are provided to each terminal 10, 20, 30 and 40 of the debate participants.

Additionally, the debate solution providing system may determine who is a speaker based on a debate format, e.g., a CEDA format, designated in the debate room and control each terminal 10, 20, 30 and 40 of the debate participants so that a determined speaker may speak.

Helping a speaker speak may mean that the debate solution providing system transmits only voice information received from a terminal e.g., 10 of a speaker to a terminal 20, 30 and 40 of the other debate participants through the debate server 100 and does not transmit voice information received from the terminal 20, 30 and 40 of debate participants who do not have a right to speak to the terminal 10, 20, 30 and 40 of other debate participants.

For example, when a current speaker as illustrated in FIG. 8 is a first speaker of an affirmative team in a CEDA format and make a constructive speech, a second speaker e.g., a debate participant corresponding to a debate UI 230 of a negative team will subsequently get a speaking opportunity for cross-examination after speaking time of a current speaker is over.

When a speaker having a speaking opportunity violates speaking time, the debate solution providing system may control so that voice information of the speaker may not be delivered to the other debate participants automatically, or may allow a predetermined time to speak more in a speaking time. Moreover, the debate solution providing system may subtract debate scores of the speaker as much as predetermined point when the speaker does not keep a speaking time. A remaining speaking time of a speaker may be displayed in a region of a debate UI 200 corresponding to a speaker or a region of an entire screen.

In addition, the debate solution providing system may transmit predetermined information to a terminal 10, 20, 30 and 40 of the debate participants to inform who a current speaker is. For this, the debate solution providing system may display a debate UI 200 corresponding to a speaker who has a speaking opportunity differently from each of a debate UI 210, 220, 230 of the other debate participants.

For example, a predetermined icon in a form of mike may be displayed at a debate UI 200 corresponding to a current speaker as illustrated in FIG. 8. According to an example embodiment, the debate UI 200 corresponding to a speaker may be displayed even bigger than other debate UI 210, 220 and 230 or displayed in a center of a terminal 10, 20, 30 and 40 of the debate participants.

On the other hand, the debate solution providing system may record speeches of each of the debate participants, classifying them by speaker or feature of speech of a speaker. Recorded information may be stored in the debate server 100. Speeches and/or image information by speaker may be recorded and the speeches and/or the image information may be recorded by a feature of speeches (e.g., constructive speech, cross-examination or rebuttal speech) of a speaker. Accordingly, debate participants may monitor their speeches again after a debate is over, and may use it as educational data.

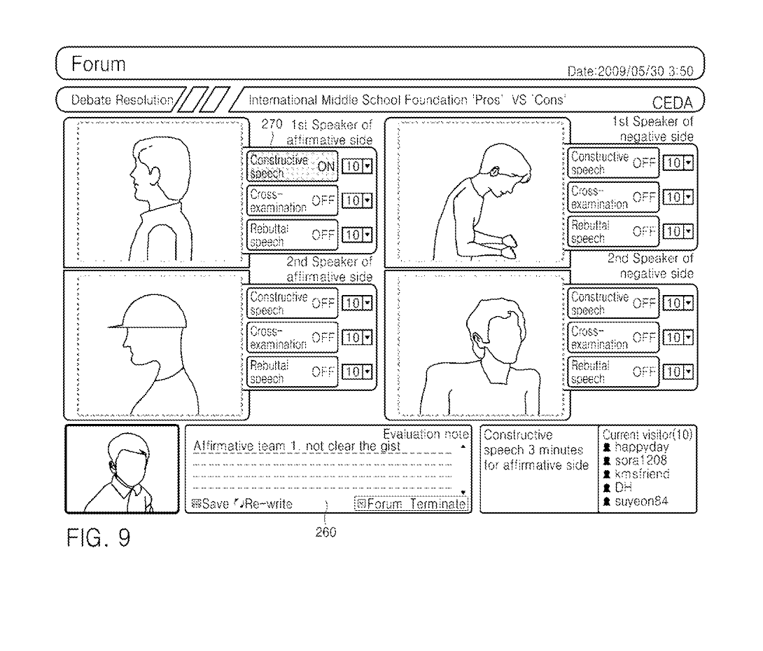

FIG. 9 is an example embodiment of the screen which the debate solution providing system provides to each terminal of debate participants according to another example embodiment of the present inventive concepts.

Referring to FIG. 9, it is known that a predetermined UI 270 indicating a feature of speaker's speeches is more displayed on each terminal 10, 20, 30 and 40 of debate participants compared to FIG. 8.

In addition, a judge may do a predetermined comments or evaluation which debate participants may check while a debate is proceeding or after the debate is over. The judge may perform an evaluation by speaker or by debate team at real time through an evaluation note

UI 260. Evaluation information input through the evaluation note UI 260 may be stored in the debate server 100, and it may be supplied with a predetermined file which is recorded by speaker or feature of speaker's speeches. Moreover, the debate solution providing system may control so that comments may be shown only to an object that a judge comments on.

A judge not only simply inputs comments during a debate, but also calculates a debate score by debate participant or calculates a score by debate team. When calculating scores, the judge may briefly leave a comment for score calculation. After a debate is over, participants may improve their debate competence by checking not only scores the judge calculated but also the comment. According to calculated scores in case of team debate or individual debate, a winner of debate is determined.

Accordingly, a debate solution providing system of the present inventive concepts may provide a technical concept which holds and/or performs a debate contest on line. Scores by debate participant or team are not only calculated by a judge but also calculated automatically by a predetermined standard set in advance in the debate solution providing system.

For example, when a speaker violates a speaking time, the debate solution providing system may subtract a pre-determined score from scores of the speaker or team of speaker. Besides, when slang or dialect which should not be used in a debate is used, the debate solution providing system may recognize it and subtract a pre-determined score from scores of the speaker or team of speaker. Other various standards may be set in advance and they may be used in calculating debate scores. In addition, scores which the judge calculates is also not calculated arbitrarily by the judge, but information on scoring item and standard may be given to a judge in advance and the judge may score by each item.

When winner (or victory) or loser (or defeat) of each of debate participants or a debate team is decided based on scores calculated in this way, each of the debate participants or the debate team may participate in a next round of a debate contest based on a judged winner or loser in case the debate solution providing system hold a debate contest in a tournament. Accordingly, a winner of a debate contest may be determined and a debate contest may be formed on line at low cost, so that it may boost an interest of participants. Of course, participants may perform a normal debate rather than a contest through the debate solution providing system according to an example embodiment.

FIGS. 4 to 7 illustrate a debate operation method such as a Lincoln-Douglas Debate format, a Parliamentary Debate format, a Karl-Popper debate format, and a British Parliamentary style debate format, respectively, and the debate solution providing system may control each of a terminal 10, 20, 30 or and 40 of debate participants based on a method illustrated in FIGS. 4 to 7. Furthermore, a required time may be changed by each debate format according to an example embodiment.

A debate solution providing method according to an example embodiment of the present inventive concepts may be embodied in a computer-readable code in a computer-readable recording medium. The computer-readable recording medium includes all kinds of recording devices storing data which may be read by a computer system. An example of the computer-readable recording medium includes a read only memory (ROM), a random access memory (RAM), a CD-ROM, a hard disk, and an optical data storage device. Additionally, the computer-readable recording medium is dispersed in a computer system connected in a network, so that a computer-readable code may be stored and performed in a dispersion mode. Besides, a functional program, a code and code segments for embodying the present inventive concepts may be easily inferred by programmers of the art where the present inventive concepts belong.

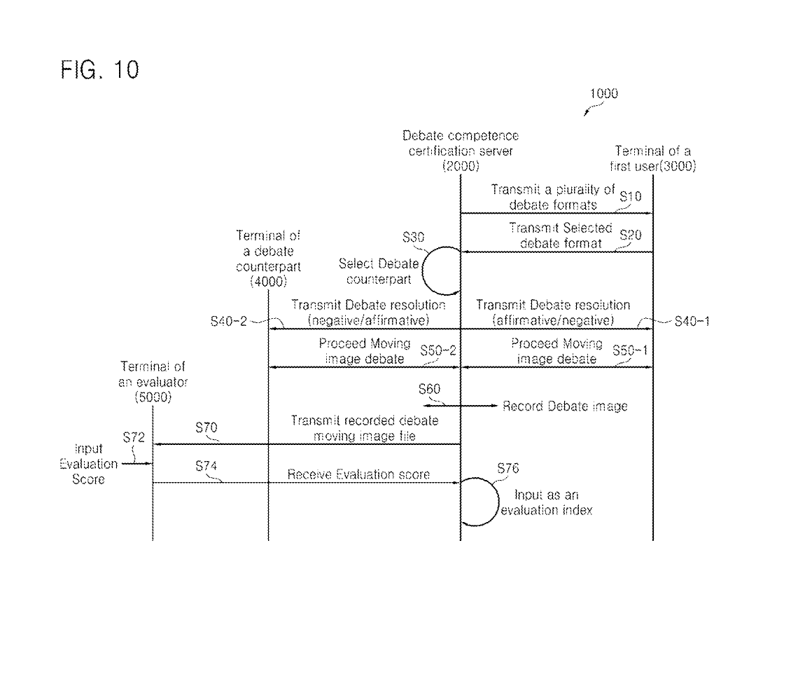

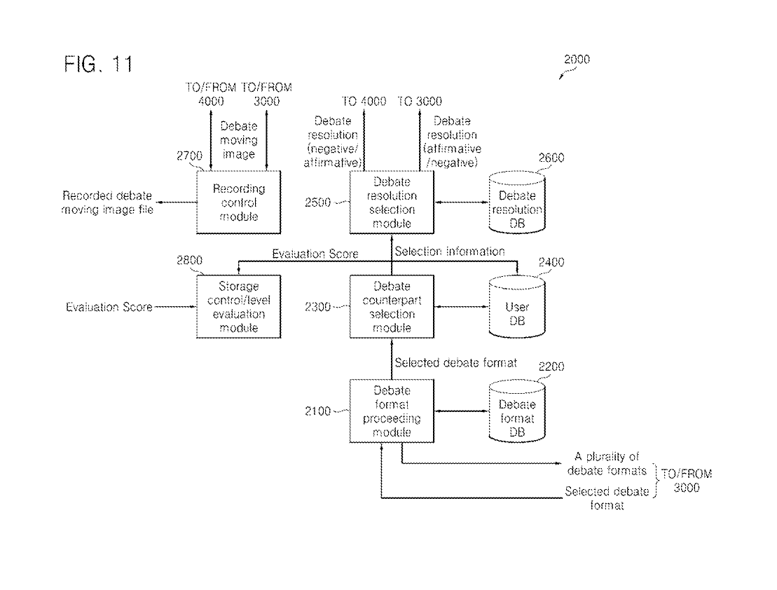

FIG. 10 is a schematic data flow of a system which may perform an on-line debate competence certification method according to an example embodiment of the present inventive concepts, and FIG. 11 is a schematic block diagram of an on-line debate competence certification server illustrated in FIG. 10.

Referring to FIGS. 10 and 11, an on-line debate competence certification system 1000 includes an on-line debate competence certification server 2000, a terminal 3000 of a first user, a terminal 4000 of a second user, and a terminal 5000 of an evaluator (or judge). For convenience of explanation, FIG. 10 illustrates a terminal of a second user 4000 and a terminal of an evaluator 5000; however, the terminal of the second user 4000 may be plural and the terminal of the evaluator may also be plural.

Each terminal 3000, 4000 and 5000 means all communication terminals which may transmit or receive data, e.g., text data, voice data or moving image data, with the on-line debate competence certification server 2000 through a wire communication network or a wireless communication network.

Each terminal 3000, 4000 and 5000 means a communication terminal which may process moving image and voice such as a desktop computer, a portable computer, a cellular phone, a smart phone or a personal digital assistant (PDA), and may perform moving image or an image debate through web camera-based application or solution. The application or the solution may be installed in each terminal 3000, 4000 and 5000.

Each user, who wants to get their debate competence certification on line according to an example embodiment of the present inventive concepts, may use a web page provided in the on-line debate competence certification server 2000 and become a member. Accordingly, a first user and a second user assumed to be members after finishing getting membership.

First of all, a first user connects to the on-line debate competence certification server 2000 using a terminal 3000 to certificate or improve debate competence.

A debate format processing module 2100 transmits various debate format (or information on various debate formats) stored in a debate format database 2200 to the terminal 3000 of the first user (S10). The various debate formats (or types) includes a cross examination debate association (CEDA) format, a Lincoln-Douglas Debate format, a Parliament Debate format, a Karl-Popper Debate format or a British Parliament style debate format. Additionally, the various debate formats include a one to one (1:1) debate format, and a n to m (n:m) debate format (n and m are natural numbers, n=m or n≠m).

The first user may select one of a plurality of debate formats provided from the debate format processing module 2100 of the on-line debate competence certification server 2000. The first user may select one of the plurality of debate format by using a user interface (UI) displayed in a computer 3000 of the first user.

When the first user selects one of the plurality of debate formats, a selected debate format (or information on a selected debate format) is supplied to the debate format processing module 2100 through the terminal 3000 of the first user (S20). The debate format processing module 2100 transmits a selected debate format to a debate counterpart selection module 2300.

The debate counterpart selection module 2300 may search for a plurality of second users corresponding to a debate competence level of a first user from a user database 2400 and select at least one of a plurality of searched second users randomly as a debate counterpart (S30).

A debate competence level, an evaluation score and the number of debate participation by user are stored in the user database 2400.

When a counterpart is one based on a debate format selected by a first user (e.g., a one to one debate), the debate counterpart selection module 2300 may select randomly one of a plurality of second users belonging to a debate competence level the same as a debate competence level of the first user as a debate counterpart (S30).

In addition, when counterparts are more than two based on a debate format selected by the first user (e.g., a one to K (K is a natural number) debate), the debate counterpart selection module 2300 may select randomly more than two among a plurality of second users belonging to a debate competence level the same as a debate competence level of the first user as debate counterparts (S30).

According to an example embodiment, the debate counterpart selection module 2300 may select randomly at least one of a plurality of second users belonging to a debate competence level different from a debate competence level of the first user as a debate counterpart.

A debate competence level (or a debate grade) of the first user may be determined to one of a plurality of debate competence levels based on the number of participation in a debate provided by the on-line debate competence certification server 2000. For example, the 6^{th} grade in case the number of participation is less than 20 times, the 5^{th} grade in case it is less than 40 times, the 4^{th} grade in case it is less than 60 times, the 3^{rd} grade in case it is less than 80 times, the 2^{nd} grade in case it is less than 100 times, and the 1^{st} grade in case it is more than 120 times.

According to another example embodiment, a debate competence level (or debate grade) of the first user may be changed based on at least one of the number of debate participation, victory or defeat of debate evaluated by at least one evaluator (or judge) at every debate participation, or an evaluation score evaluated from at least one evaluator (or judge) at every debate participation. A debate competence level of the first user may be provided in a form of rank (or an evaluation grade having another name) by the on-line debate competence certification server 2000.

A debate resolution selection module 2500 may transmit a debate resolution (e.g., the gist of a debate) selected randomly among a plurality of debate resolutions stored in a debate resolution database 2600 to a terminal 3000 of a first user and a terminal of a debate counterpart (e.g., a terminal 4000 of a second user) based on selection information of at least one debate counterpart selected by the debate counterpart selection module 2300, e.g., ID of a counterpart (S40-1 and S40-2).

According to an example embodiment, the debate resolution selection module 2500 may transmit one of an affirmative gist of a debate and a negative gist of the debate on a selected debate resolution to a terminal 3000 of a first user (S40-1) and transmit the other of the affirmative gist and the negative gist on the debate resolution to a terminal 4000 of a second user.

According to an example embodiment, the debate resolution selection module 2500 may store how many times a first user performs a debate on an affirmative point and on a negative point in the user database 2400, and distribute an affirmative point or a negative point on a debate resolution fairly to the first user referring to a stored record.

A reason why each of the affirmative point and the negative point is transmitted to each of terminals 3000 and 4000 before a debate starts is to give users time to proceed a moving image debate based on a selected debate format after preparing an affirmative view (point) and a negative view (point) on a given debate resolution selected by a first user.

When a debate starts, a recording control module 2700 records a debate moving image received through a camera (not shown) installed in the terminal 3000 of the first user and a debate moving image received through a camera (not shown) installed in the terminal 4000 of the debate counterpart (e.g., a second user) while proceeding a moving image debate between the first user and the debate counterpart (e.g., a second user) (S60), and transmits a recorded debate moving image file to a terminal 5000 of an evaluator when the moving image debate is over (S70).

According to an example embodiment, the recording control module 2700 may give a fixed debate time to each of a first user and a second user by turns. Additionally, the recording control module 2700 may check if debate time allowed to each of the first user and the second user is exceeded and hand over right to speak (or a debate time) to an opposite when allowed debate time is exceeded.

In addition, the recording control module 2700 may hand over right to speak (or a debate time) to an opposite in response to a signal input from each of the computer 3000 of the first user and the computer 4000 of the second user even within a debate time allowed for each of the first user and the second user.

An evaluator (or a judge) evaluates each of a first user and a second user debating in a recorded debate moving image file based on a standardized evaluation table and input an evaluation score (e.g., simply victory or defeat or how many scores out of a possible 100) to a terminal 5000 of the evaluator (S72).

A storage control/level evaluation module 2800 receives an evaluation score for each of the first user and the debate counterpart (e.g., a second user) transmitted from the terminal 5000 of the evaluator (S74), and stores an evaluation score for each user in the user database 2400 as an evaluation index (S73).

The storage control/level evaluation module 2800 may change, based on an evaluation score for each of a first user and a second user stored in the user database 2400 as the evaluation index, a debate competence level or grade of each of the first user and the second user.

For example, the storage control/level evaluation module 2800 may change a debate competence level or grade of each user based on at least one of the number of debate participation, victory or defeat of debate evaluated by at least one evaluator at every debate participation or an evaluation score evaluated by at least one evaluator at every debate participation.

An operator of the on-line debate competence certification server 2000 may evaluate a debate competence level of each user and issue a debate certificate suited for the debate competence of the each user.

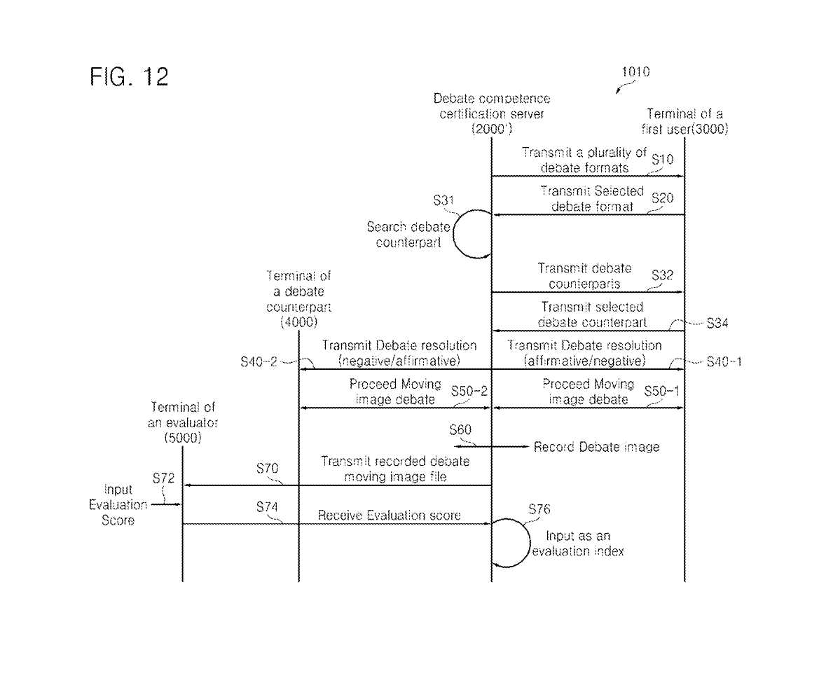

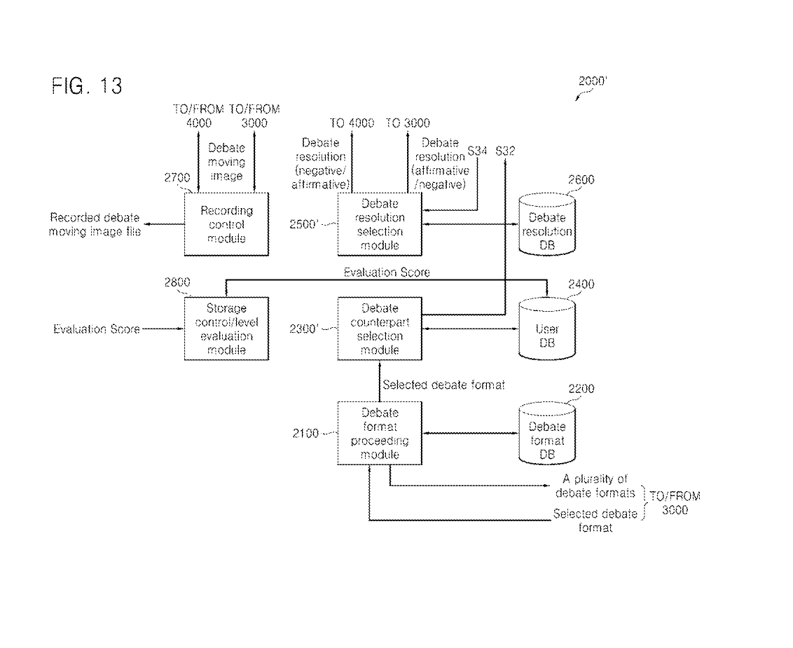

FIG. 12 is a schematic data flow of a system which may perform the on-line debate competence certification method according to another example embodiment of the present inventive concepts, and FIG. 13 is a schematic block diagram of the on-line debate competence certification server illustrated in FIG. 12.

Referring to FIGS. 12 and 13, an on-line debate competence certification system 101 includes an on-line debate competence certification serer 2000′, a terminal 3000 of a first user, a terminal 4000 of a second user, and a terminal 5000 of an evaluator (or judge).

The first user connects to an on-line debate competence certification server 2000′ to certificate or improve debate competence using the terminal 3000.

The debate format processing module 2100 of the on-line debate competence certification server 2000′ transmits various debate format stored in the debate format database 2200 to the terminal 3000 of the first user (S10). The various debate format includes a cross examination debate association (CEDA) format, a Lincoln-Douglas Debate format, a Parliamentary Debate format, a Karl-Popper Debate format, a British Parliamentary style debate format, a one to one (1:1) debate format, or a n to m (n:m) debate format (n and m are natural numbers).

The first user may select one of a plurality of debate format provided from the debate format processing module 2100 of the on-line debate competence certification server 2000′.

When the first user selects one of the plurality of debate format, a selected debate format is provided to the debate format processing module 2100 through the terminal 3000 of the first user (S20). The debate format processing module 2100 transmits a selected debate format to a debate counterpart selection module 2300′.

The debate counterpart selection module 2300′ searches for a plurality of second users corresponding to a debate competence level of the first user from the user database 2400 based on a selected debate format output from the debate format processing module 2100 (S31), and transmits information on a plurality of searched second users to the terminal 3000 of the first user (S32).

When a first user selects at least one of a plurality of second users transmitted from the on-line debate competence certification server 2000′ as a debate counterpart, the terminal 3000 of the first user transmits information on a selected debate counterpart to the debate resolution selection module 2500′ (S34).

At least a debate counterpart to debate with the first user may be selected by the debate counterpart selection module 2300 as illustrated in FIG. 11 or may be selected by a first user.

The debate resolution selection module 2500′ may transmit a debate resolution selected randomly among a plurality of debate resolution stored in the debate resolution database 2600 to the terminal 3000 of the first user and a terminal of a debate counterpart (e.g., a terminal 4000 of a second user) in response to selection information output from the terminal 3000 of the first user (S40-1 and S40-2).

According to an example embodiment, the debate resolution selection module 2500′ may transmit one of an affirmative point and a negative point on a selected debate resolution to the terminal 3000 of the first user (S40-1) and transmit the other of the affirmative point and the negative point on the debate resolution to the terminal 4000 of the second user.

Operating steps S50-1 to S76 illustrated in FIG. 12 are the same as S50-1 to S76 illustrated in FIG. 10, so that detailed explanation for it is omitted.

According to an example embodiment, a first user may select (i) a debate format, (ii) a debate format and a debate counterpart, (iii) a debate format, a debate counterpart, and an affirmative view (point) or a negative view (point) on a debate resolution.

### INDUSTRIAL APPLICABILITY

The present inventive concept may be applied to a debate solution providing system.

1. A debate solution providing system comprising:
wherein the debate solution providing system,
opens a debate room having a debate resolution,
controls so that image information of each of debate participants participating in the opened debate room may be transmitted to a terminal of each of the debate participants and displayed on a debate user interface (UI) corresponding to each of the debate participants,
determines a speaker among the debate participants based on a pre-determined debate format,
controls a terminal of each of the debate participants so that a speaking opportunity may be given to a determined speaker,
enables a judge to enter the debate room through a terminal of the judge,
controls so that a judgment comment input through the terminal of the judge may be transmitted to the terminal of each of the participants or a terminal of a participant selected by the judge among the participants and displayed during a debate, and
calculates a debate result score of each of the debate participants or a team score of at least a team consisting of the debate participants based on at least one of a first debate score, which is determined by a debate determination standard set in advance in the debate solution providing system, and a second debate score, which is calculated by judgment of the judge and input through the terminal of the judge.

2. The debate solution providing system of claim 1, wherein the debate solution providing system makes at least one of the debate participants select one of the pre-determined debate formats, and opens the debate room operated based on a selected debate format.

3. The debate solution providing system of claim 1, wherein the debate solution providing system may divide and record speeches of each of the debate participants by speaker or by feature of speeches of speaker.

4. The debate solution providing system of claim 1, wherein the debate solution providing system displays a debate UI corresponding to a speaker who is granted a speaking opportunity separately from a debate UI of other debate participants.

5. The debate solution providing system of claim 4, wherein the debate solution providing system controls so that remaining time of the speaking opportunity may be displayed on a terminal of the speaker who is granted the speaking opportunity.

6. The debate solution providing system of claim 1, wherein the debate solution providing system judges victory or defeat of each of the debate participants or the debate team based on the debate result score or the team score, and determines whether each of the debate participants or the debate team participates in a next round of a debate contest run in tournament by the debate solution providing system based on a judged victory or defeat.

7. The debate solution providing system of claim 1, wherein the debate format includes at least one of a cross examination debate association (CEDA) format, a Lincoln-Douglas Debate format, a Parliamentary Debate format, a Karl-Popper Debate format, or a British Parliamentary style debate format.

8. An on-line debate competence certification method comprising:
receiving, by a server, one of a plurality of debate formats, which is selected by a first user, through a terminal of the first user;
selecting, by the server, at least one of a plurality of second users corresponding to a debate competence level of the first user as a counterpart based on a received debate format;
transmitting, by the server, a debate resolution to the terminal of the first user and a terminal of the debate counterpart;
recording, by the server, debate moving image received through the terminal of the first user and debate moving image received through the terminal of the counterpart while proceeding a moving image debate between the first user and the debate counterpart;
transmitting, by the server, a recorded debate moving image file to a terminal of an evaluator when the moving image debate is over; and
storing, by the server, an evaluation score for each of the first user and the debate counterpart transmitted from the terminal of the evaluator as an evaluation index for changing a debate competence level of each of the first user and the debate counterpart,
wherein the plurality of debate format include a cross examination debate association (CEDA) format, a Lincoln-Douglas Debate format, a Parliamentary Debate format, a Karl-Popper Debate format, a British Parliamentary style debate format, a one to one debate format or an n to m (n and m are natural numbers) debate format.

9. The method of claim 8, wherein the debate resolution is randomly selected by the server among a plurality of debate resolution, and an affirmative point of the debate resolution is transmitted to one of the terminal of the first user and the terminal of the debate counterpart and a negative point on the debate resolution is transmitted to the other of the terminal of the first user and the terminal of the debate counterpart.

10. The method of claim 8, further comprising transmitting, by the server, a plurality of debate resolutions to the terminal of the first user, wherein the server transmits the debate resolution, which is selected by the first user among the plurality of debate resolutions and input through the terminal of the first user, to the terminal of the first user and the terminal of the debate counterpart.

11. An on-line debate competence certification method comprising:
receiving, by a server, one of a plurality of debate formats, which is selected by a first user, through a terminal of the first user;
transmitting, by the server, information on a plurality of second users corresponding to a debate competence level of the first user based on a received debate format to the terminal of the first user;
generating, by the server, a debate resolution in response to selection information input through the terminal of the first user and transmitting a generated debate resolution to the terminal of the first user and a terminal of the debate counterpart when at least one of the plurality of second users is selected by the first user as a debate counterpart;
recording, by the server, moving image received through the terminal of the first user and moving image received through the terminal of the debate counterpart while proceeding a moving image debate between the first user and the debate counterpart;
transmitting, by the server, a recorded moving image file to a terminal of an evaluator when the moving image debate is over; and
storing, by the server, an evaluation score for each of the first user and the debate counterpart, which is transmitted from the evaluator, as an evaluation index for changing a debate competence level of each of the first user and the debate counterpart,
wherein the plurality of debate formats include a cross examination debate association (CEDA) format, a Lincoln-Douglas Debate format, a Parliamentary Debate format, a Karl-Popper Debate format, a British Parliamentary style debate format, an one to one debate format, or an n to m (n and m are natural numbers) debate format.

12. A computer-readable recording medium recording a computer program for performing the on-line debate competence certification method of claim 8.

13. An on-line debate competence certification server comprising:
a debate format processing module for transmitting a plurality of debate formats to a terminal of a first user and receiving one of the plurality of debate formats, which his selected by the first user, through a terminal of the first user;
a debate counterpart selection module for selecting at least one of a plurality of second users corresponding to a debate competence level of the first user as a debate counterpart based on a debate format output from the debate format processing module;
a debate resolution selection module for transmitting a debate resolution, which is selected randomly among a plurality of debate resolutions, to the terminal of the first user and the terminal of the debate counterpart in response to selection information output from the debate counterpart selection module;
a recording control module for recording a debate moving image received through the terminal of the first user and a debate moving image received through the terminal of the debate counterpart while proceeding a moving image debate between the first user and the debate counterpart and transmitting a recorded debate moving image file to a terminal of an evaluator when the moving image debate is over; and
a storage control module for controlling storage of an evaluation score for each of the first user and the debate counterpart transmitted from the terminal of the evaluator as an evaluation index for changing a debate competence level of each of the first user and the debate counterpart,
wherein the plurality of debate formats include a cross examination debate association (CEDA) format, a Lincoln-Douglas Debate format, a Parliamentary Debate format, a Karl-Popper Debate format, a British Parliamentary style debate format, an one to one debate, and an n to m (n and m are natural numbers) debate format.

14. An on-line debate competence certification system comprising:
a terminal of a first user;
a terminal of a debate counterpart; and
an on-line debate competence certification server for recording a debate moving image received through the terminal of the first user and a debate moving image received through the terminal of the debate counterpart while proceeding a moving image debate between the first user and the debate counterpart,
wherein the on-line debate competence certification server includes:
a debate format processing module for transmitting a plurality of debate formats to the terminal of the first user and receiving one of the plurality of debate formats, which is selected by the first user, through the terminal of the first user;
a debate counterpart selection module for selecting at least one of a plurality of second users corresponding to a debate competence level of the first user as a debate counterpart based on a debate format output from the debate format processing module;
a debate resolution selection module for transmitting a debate resolution, which is selected randomly among a plurality of debate resolutions, to the terminal of the first user and the terminal of the debate counterpart in response to selection information output from the debate counterpart selection module;
a recording control module for transmitting a recorded debate moving image file to a terminal of an evaluator when the moving image debate is over; and
a storage control module for controlling storage of an evaluation score for each of the first user and the debate counterpart, which is transmitted from the terminal of the evaluator, as an evaluation index for changing a debate competence level of each of the first user and the debate counterpart,
wherein the plurality of debate formats include a cross examination debate association (CEDA) format, a Lincoln-Douglas Debate format, a Parliamentary Debate format, a Karl-Popper Debate format, a British Parliamentary style debate format, an one to one debate, and an n to m (n and m are natural numbers) debate format.
